(19) United States
(12) Patent Application Publication
(10) Pub. No.: US 2014/0204917 A1
(43) Pub. Date: Jul. 24, 2014

(54) Method of Managing Packet Transmission for Wireless System

(71) Applicant: Ralink Technology Corp., Hsinchu County (TW)

(72) Inventors: Yu-Ju Lee, Miaoli County (TW); Po-Hsun Huang, New Taipei City (TW); Sheng-Da Chiang, Kaohsiung City (TW); You-Duan Chen, New Taipei City (TW); Shih-Chin Jung, Hsinchu City (TW); Ching-Hwa Yu, Tainan City (TW); Chia-Hsiang Hsu, Kaohsiung City (TW)

(73) Assignee: Ralink Technology Corp., Hsinchu County (TW)

(21) Appl. No.: 14/096,020

(22) Filed: Dec. 4, 2013

Related U.S. Application Data
(60) Provisional application No. 61/756,053, filed on Jan. 24, 2013.

(51) Int. Cl. H04L 5/00

(52) U.S. Cl. CPC H04L 5/0064
USPC 370/336; 370/329

(57) ABSTRACT

A method of managing packet transmission for a first wireless system wherein the first wireless system coexists with at least one second wireless system includes receiving a first type of packet of the first wireless system; determining whether the step of receiving the first type of packet is interfered by a second type of packet of one of the at least one second wireless system; and modifying a priority of the first type of packet when the first type of packet is interfered.

### CROSS REFERENCE TO RELATED APPLICATIONS

This application claims the benefit of U.S. Provisional Application No. 61/756,053, filed on Jan. 24, 2013, the contents of which are incorporated herein by reference.

### BACKGROUND

The present invention relates to a method of managing packet transmission for a wireless system, and more particularly, to a method of allocating priorities for various types of packets in the wireless system.

With rapid development of wireless communication technology, mobile communication products have become indispensable in daily life. In a wireless communication system, data is transferred between two or more points via the air without wire connections. Such communication allows a mobile device to be connected to the network when the mobile device moves from place to place.

The time division multiplexing technique is widely utilized for reducing interference between various wireless systems. In a time division mechanism, each wireless system can only transmit data within an allocated time period. However, a packet of a wireless system may be longer than the time period allocated to the wireless system, such that this packet may always be discarded when the time period allocated to the wireless system expires. Thus, there is a need for improvement over the prior art.

### SUMMARY

It is therefore an objective of the present invention to provide a method of managing packet transmission for a wireless system capable of allocating priorities for various types of packets in the wireless system.

The present invention discloses a method of managing packet transmission for a first wireless system, wherein the first wireless system coexists with at least one second wireless system. The method comprises receiving a first type of packet of the first wireless system; determining whether the step of receiving the first type of packet is interfered by a second type of packet of one of the at least one second wireless system; and modifying a priority of the first type of packet when the first type of packet is interfered.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless fidelity (Wi-Fi) system and a Bluetooth (BT) system coexisting in a time division multiplexing system.

FIG. 2 is a schematic diagram of a method of assigning different priorities to the wireless systems shown in FIG. 1 in different time periods.

FIG. 3 is a schematic diagram of a process 30 according to an embodiment of the present invention.

FIG. 4 is a schematic diagram of a Wi-Fi system and a BT system coexisting in a time division multiplexing system according to an embodiment of the present invention.

### DETAILED DESCRIPTION

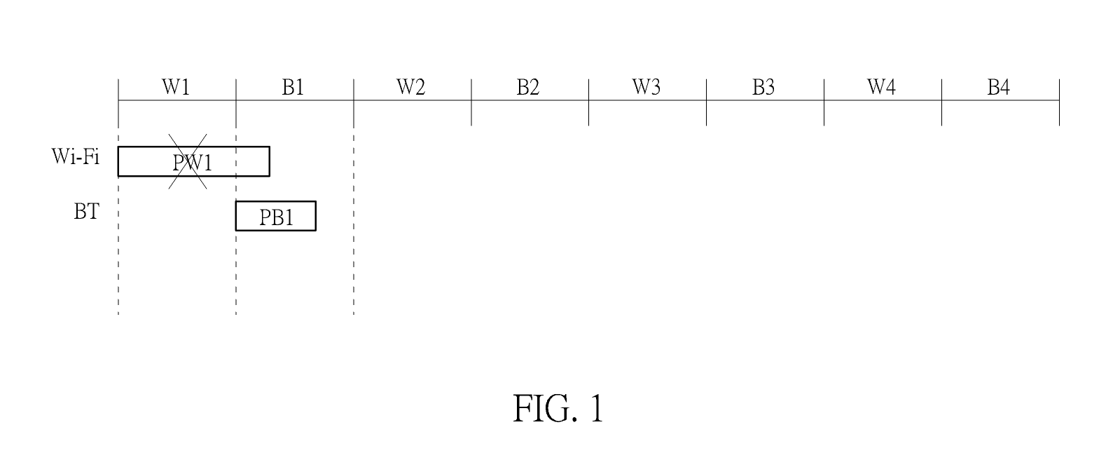

As mentioned above, the time division multiplexing cannot deal with a packet whose length is longer than a time period allocated to the packet. For example, please refer to FIG. 1, which is a schematic diagram of a wireless fidelity (Wi-Fi) system and a Bluetooth (BT) system coexisting in a time division multiplexing system. As shown in FIG. 1, the Wi-Fi system is allowed to transmit packets in time periods W1, W2, W3 and W4, and the BT system is allowed to transmit packets in time periods B1, B2, B3 and B4. A Wi-Fi packet PW1 is sent in the time period W1. Since the Wi-Fi packet PW1 is longer than the time period W1, the receiving of the Wi-Fi packet PW1 may not be accomplished when the time period W1 ends. At this moment, when a BT packet PB1 arrives and interferes with the Wi-Fi packet PW1, the Wi-Fi packet PW1 may be discarded.

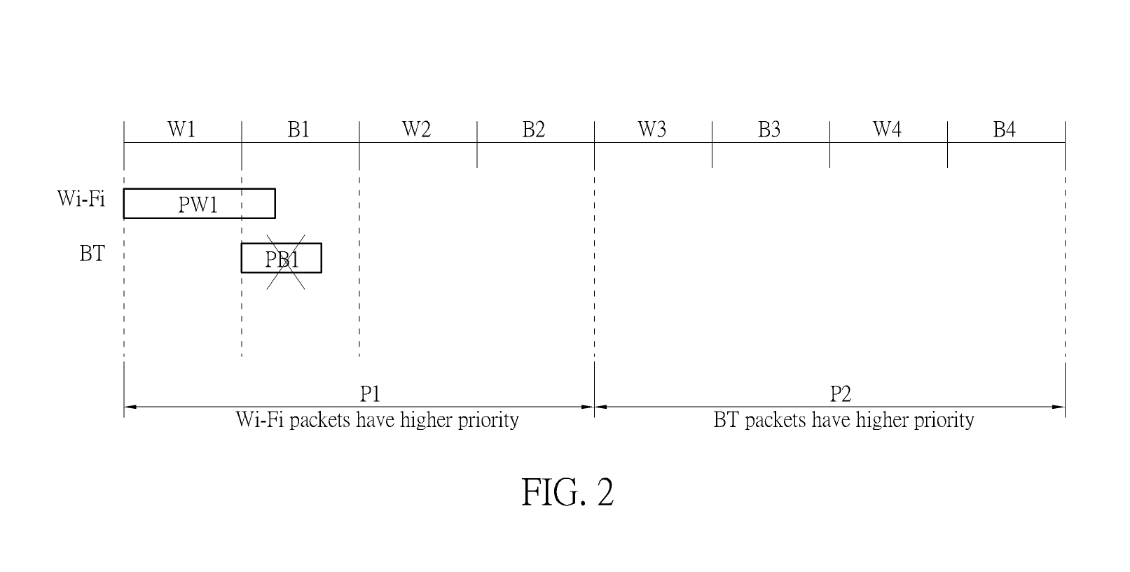

In order to solve this problem, a method of modifying priority is proposed, as shown in FIG. 2. FIG. 2 illustrates a method of assigning different priorities to the wireless systems shown in FIG. 1 in different time periods, in order to allow the longer packets to be received successfully in specific time periods. In a time period P1, the Wi-Fi packets have a higher priority than the BT packets, so that if a Wi-Fi packet is interfered by a BT packet in the time period P1, the BT packet may be discarded. In a time period P2, the BT packets have a higher priority than the Wi-Fi packets, so that if a BT packet is interfered by a Wi-Fi packet in the time period P2, the Wi-Fi packet may be discarded. The time periods P1 and P2 are longer periods for priority allocation, where the time period P1 includes the time periods W1, B1, W2 and B2, and the time period P2 includes the time periods W3, B3, W4 and B4. In such a condition, if the long packet PW1 is received in the time period P1 and interfered by the packet PB1, the long packet PW1 may be received successfully.

However, the BT packet PB1 may be discarded when the above method is applied. Sometimes this BT packet PB1 may be more important than the Wi-Fi packet PW1, but the BT packet PB1 is discarded when the interference occurs in the time period P1. Thus, it is desirable to allocate a priority to each packet according to the importance of each packet, in order to select the most important packet when two or more packets interfere with each other.

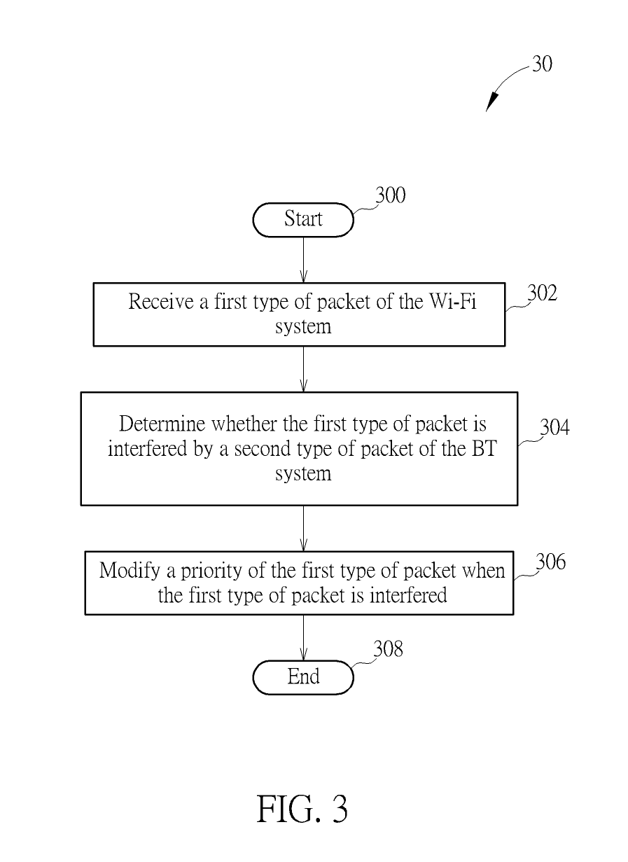

Please refer to FIG. 3, which is a schematic diagram of a process 30 according to an embodiment of the present invention. The process 30 is utilized in a wireless system such as Wi-Fi, wherein the Wi-Fi system may coexist with a BT system. As shown in FIG. 3, the process 30 includes the following steps:

Step 300: Start.

Step 302: Receive a first type of packet of the Wi-Fi system.

Step 304: Determine whether the first type of packet is interfered by a second type of packet of the BT system.

Step 306: Modify a priority of the first type of packet when the first type of packet is interfered.

Step 308: End.

According to the process 30, the Wi-Fi system first receives a Wi-Fi packet. If the Wi-Fi packet is not interfered by other packets, this Wi-Fi packet may be received successfully. If the Wi-Fi packet is interfered by a BT packet, an arbitration mechanism should be applied to determine which one among the Wi-Fi packet and the BT packet could be received.

In the convention method as shown in FIG. 2, no matter which packet is more important, the Wi-Fi packet is always received and the BT packet is discarded in a fixed period such as the time period P1, and the BT packet is always received and the Wi-Fi packet is discarded in a fixed period such as the time period P2. In such a condition, several important packets may be discarded. In comparison, according to the present invention, when the Wi-Fi packet is interfered by the BT packet, the wireless system may modify the priority of the Wi-Fi packet if the interference occurs.

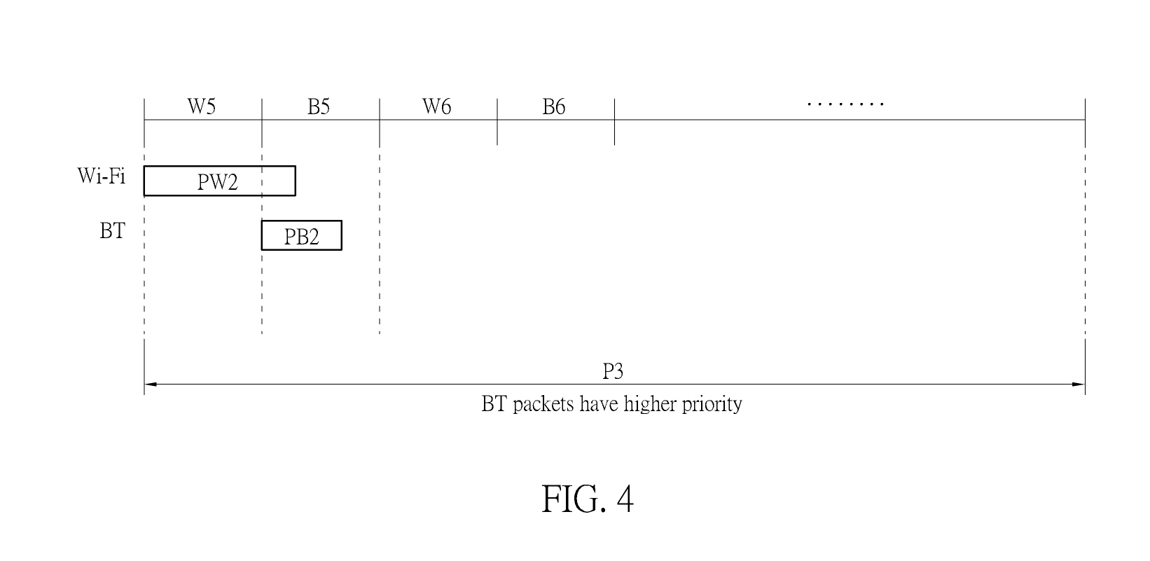

For example, please refer to FIG. 4, which is a schematic diagram of a Wi-Fi system and a BT system coexisting in a time division multiplexing system according to an embodiment of the present invention. In this embodiment, the Wi-Fi system is allowed to transmit packets in time periods W5 and W6, and the BT system is allowed to transmit packets in time periods B5 and B6. A long Wi-Fi packet PW2 and a BT packet PB2 interfere with each other in a time period P3 when the BT packet PB2 has a higher priority. When the interference occurs, the wireless system may not discard the Wi-Fi packet PW2 directly; instead, it determines whether the Wi-Fi packet PW2 satisfies a priority determining criterion according to the embodiment of the present invention. If the criterion is satisfied, the priority of the Wi-Fi packet PW2 is increased to be higher than the priority of the BT packet PB2, so that the Wi-Fi packet PW2 may be received and the BT packet PB2 may be discarded. If the criterion is not satisfied, the wireless system retains the priority of the Wi-Fi packet PW2, so that the BT packet PB2 may be received and the Wi-Fi packet PW2 may be discarded.

In an embodiment, the packet length may be considered as a criterion for priority determination. For example, if the length of a Wi-Fi packet is longer than a threshold, the wireless system increases the priority of the Wi-Fi packet; if the length of a Wi-Fi packet is shorter than the threshold, the wireless system retains the priority of the Wi-Fi packet. Furthermore, if the long packets longer than a time period allocated for the Wi-Fi system in the time division multiplexing need to be protected, the priority for these long packets may be increased when facing the interference.

In an embodiment, the receiving of these long Wi-Fi packets and other packets of different wireless systems such as a BT system can be well controlled. The wireless system may originally set the priority of the long Wi-Fi packets to be lower than the BT packets, and the long Wi-Fi packets may be discarded when packet interference occurs. After a specific number of long Wi-Fi packets are discarded, the wireless system increases the priority of the long Wi-Fi packets to be higher than the BT packets, and receives the following long Wi-Fi packets. After a specific number of long Wi-Fi packets are received successfully, the wireless system recovers the priority of the long Wi-Fi packets to be lower than the BT packets, and discards the following long Wi-Fi packets. In this way, tradeoff between the receiving of the long Wi-Fi packets and the BT packets may be balanced.

The modification of priority can be implemented in any feasible manners. In an embodiment, the modification of the priority of the Wi-Fi packets is performed in a hardware manner. In such a condition, the hardware of the wireless system modifies the priority of a current Wi-Fi packet when the current Wi-Fi packet satisfies the priority determining criterion. For example, if the priority of long Wi-Fi packets is increased in the hardware manner when the long Wi-Fi packet PW2 is interfered by the BT packet PB2, the current long Wi-Fi packet PW2 may be successfully received by immediately increasing the priority of long packets. Following long Wi-Fi packets may also be received successfully when interfered by BT packets. In another embodiment, the modification of the priority of the Wi-Fi packets is performed in a software manner. In such a condition, the wireless system sends an interrupt signal to a processing unit (e.g. a micro-processing unit (MCU)) to modify the priority of following packets having the same type with the current Wi-Fi packet when the current Wi-Fi packet satisfies the priority determining criterion. For example, if the priority of long Wi-Fi packets is increased in the software manner when the long Wi-Fi packet PW2 is interfered by the BT packet PB2, following long Wi-Fi packets may be received by increasing the priority of long packets, but the current long Wi-Fi packet PW2 may be discarded since the priority may not be increased immediately when the software manner is applied.

In addition to the modification of the priority of the Wi-Fi packets, other modifications may be performed in the time division multiplexing system. In an embodiment, instead of modifying the packet priority, the time sharing schedule of the time division multiplexing system may be changed within a specific period when the Wi-Fi packet satisfies a criterion. For example, after a specific number of long Wi-Fi packets are discarded, the wireless system may increase the length of time periods where the Wi-Fi packets have a higher priority (e.g. the time period P1 shown in FIG. 2) over the next ten milliseconds, in order to receive the subsequent long Wi-Fi packets. It is worthy to be mentioned that the method of modifying the time sharing schedule of the time division multiplexing system may also be incorporated with the abovementioned method of modifying the priority.

Please note that, the present invention provides a method of managing packet transmission for a wireless system capable of allocating priorities for various types of packets in the wireless system. Those skilled in the art can make modifications and alternations accordingly. For example, the above embodiments are implemented in the time division multiplexing system with coexistence of a Wi-Fi system and a BT system, but in other embodiments, the present invention may also be applied in a time division multiplexing system with coexistence of three or more wireless systems, where these wireless systems may include Wi-Fi systems, BT systems, long-term evolution (LTE) systems, worldwide interoperability for microwave access (WiMAX) systems, and other wireless systems which may cause interference. In addition, in the above embodiments, the packet length is considered as the criterion to be satisfied for determining whether to modify the priority. In other embodiments, other criteria may also be utilized for determining whether to modify the priority, which should not be limited herein.

For example, in a time division multiplexing system with coexistence of a first wireless system and a second wireless system, when a packet of the first wireless system is interfered by a packet of the second wireless system, the first wireless system may determine whether the packet of the first wireless system comes from a specific network. If the packet of the first wireless system comes from the specific network, the first wireless system increases the priority of this packet to be higher than the packet of the second wireless system, so that the packet of the first wireless system may be received and the packet of the second wireless system may be discarded. In such a condition, the priority of following packets of the first wireless system coming from the specific network may also be increased. On the other hand, if the packet of the first wireless system comes from other networks, the first wireless system retains the priority of this packet to be lower than the packet of the second wireless system, so that the packet of the second wireless system may be received and the packet of the first wireless system may be discarded.

In an embodiment, when a packet of the first wireless system is interfered by a packet of the second wireless system, the first wireless system may determine whether the packet of the first wireless system is within a specific frequency band. If the packet of the first wireless system is within the specific frequency band, the first wireless system increases the priority of this packet to be higher than the packet of the second wireless system, so that the packet of the first wireless system may be received and the packet of the second wireless system may be discarded. In such a condition, the priority of following packets of the first wireless system within the specific frequency band may also be increased. On the other hand, if the packet of the first wireless system is not in the frequency band, the first wireless system retains the priority of this packet to be lower than the packet of the second wireless system, so that the packet of the second wireless system may be received and the packet of the first wireless system may be discarded.

In an embodiment, when a packet of the first wireless system is interfered by a packet of the second wireless system, the first wireless system may determine whether the packet of the first wireless system has a specific profile. If the packet of the first wireless system has the specific profile, the first wireless system increases the priority of this packet to be higher than the packet of the second wireless system, so that the packet of the first wireless system may be received and the packet of the second wireless system may be discarded. In such a condition, the priority of following packets of the first wireless system having the specific profile may also be increased. On the other hand, if the packet of the first wireless system does not have the specific profile, the first wireless system retains the priority of this packet to be lower than the packet of the second wireless system, so that the packet of the second wireless system may be received and the packet of the first wireless system may be discarded.

In an embodiment, when a packet of the first wireless system is interfered by a packet of the second wireless system, the first wireless system may determine whether the packet of the first wireless system is transmitted via circuit switching or packet switching. If the packet of the first wireless system is transmitted via circuit switching, the first wireless system increases the priority of this packet to be higher than the packet of the second wireless system, so that the packet of the first wireless system may be received and the packet of the second wireless system may be discarded. In such a condition, the priority of following packets of the first wireless system transmitted via circuit switching may also be increased. On the other hand, if the packet of the first wireless system is transmitted via packet switching, the first wireless system retains the priority of this packet to be lower than the packet of the second wireless system, so that the packet of the second wireless system may be received and the packet of the first wireless system may be discarded.

In an embodiment, when a packet of the first wireless system is interfered by a packet of the second wireless system, the first wireless system may determine whether the packet of the first wireless system is in a specific type such as a beacon packet, a broadcast packet or a multicast packet. For example, if the packet of the first wireless system is a beacon packet, the first wireless system may increase the priority of this beacon packet to be higher than the packet of the second wireless system, so that the beacon packet may be received and the packet of the second wireless system may be discarded. In such a condition, the priority of following beacon packets may also be increased. On the other hand, if the packet of the first wireless system is not a beacon packet, the first wireless system retains the priority of this packet to be lower than the packet of the second wireless system, so that the packet of the second wireless system may be received and the packet of the first wireless system may be discarded.

Please note that, whether to modify the priority of a packet may be determined according to a combination of various criteria mentioned above or other criteria which are not described herein. In an embodiment, several criteria may construct a reference matrix and each packet has a score according to the reference matrix. The reference matrix may include several check items such as the packet length, source of packet, packet type, and packet profile. A weight is predetermined for each of the check items, in order to calculate a score for the packet by checking these items. In such a condition, when packet interference occurs, the packet of the first wireless system may be received if the score corresponding to the packet is higher than a threshold, and may be discarded if the score is lower than the threshold.

In the prior art, each wireless system can only transmit data within an allocated time period in a time division mechanism. A packet of a wireless system may be longer than the time period allocated to the wireless system, such that this packet may always be discarded when the time period allocated to the wireless system expires. In comparison, the present invention provides a method of determining whether an arriving packet satisfies a criterion when packet interference occurs. The wireless system can therefore assign a priority to the packet according to whether the packet satisfies the criterion, so that the more important packet may always be received successfully when the packet interference occurs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing packet transmission for a first wireless system, wherein the first wireless system coexists with at least one second wireless system, the method comprising:
receiving a first type of packet of the first wireless system;
determining whether the step of receiving the first type of packet is interfered by a second type of packet of one of the at least one second wireless system; and
modifying a priority of the first type of packet when the first type of packet is interfered.

2. The method of claim 1, further comprising:
retaining the priority of the first type of packet when the first type of packet is not interfered.

3. The method of claim 1, wherein when the priority of the first type of packet is lower than a priority of the second type of packet, the step of modifying the priority of the first type of packet when the first type of packet is interfered comprises:
increasing the priority of the first type of packet to be higher than the priority of the second type of packet when the first type of packet is interfered; and
discarding the second type of packet.

4. The method of claim 3, further comprising:
retaining the priority of the first type of packet to be lower than the priority of the second type of packet when the first type of packet is not interfered; and
discarding the first type of packet.

5. The method of claim 1, further comprising:
applying a time division multiplexing to deal with packet transmission of the first wireless system and the at least one second wireless system.

6. The method of claim 5, further comprising:
changing a time sharing schedule of the time division multiplexing within a specific period when the first type of packet is interfered.

7. The method of claim 5, wherein the step of determining whether the first type of packet is interfered by the second type of packet of one of the at least one second wireless system comprises:
determining whether the first type of packet has a length longer than a time period allocated for the first wireless system in the time division multiplexing when the first type of packet is interfered by the second type of packet.

8. The method of claim 1, wherein the step of determining whether the first type of packet is interfered by the second type of packet of one of the at least one second wireless system comprises:
determining whether the first type of packet comes from a specific network when the first type of packet is interfered by the second type of packet.

9. The method of claim 1, wherein the step of determining whether the first type of packet is interfered by the second type of packet of one of the at least one second wireless system comprises:
determining whether the first type of packet is within a specific frequency band when the first type of packet is interfered by the second type of packet.

10. The method of claim 1, wherein the step of determining whether the first type of packet is interfered by the second type of packet of one of the at least one second wireless system comprises:
determining whether the first type of packet has a specific profile when the first type of packet is interfered by the second type of packet.

11. The method of claim 1, wherein the step of determining whether the first type of packet is interfered by the second type of packet of one of the at least one second wireless system comprises:
determining whether the first type of packet is transmitted via circuit switching or a packet switching when the first type of packet is interfered by the second type of packet.

12. The method of claim 1, wherein the step of determining whether the first type of packet is interfered by the second type of packet of one of the at least one second wireless system comprises:
determining whether the first type of packet is a beacon packet, a broadcast packet or a multicast packet when the first type of packet is interfered by the second type of packet.

13. The method of claim 1, wherein whether the first type of packet is interfered by the second type of packet is measured as a score corresponding to the first type of packet, wherein the score is determined according to a reference matrix having a plurality of check items wherein each check item has a weight for calculating the score.

14. The method of claim 1, wherein the step of modifying the priority of the first type of packet when the first type of packet is interfered comprises:
increasing the priority of the first type of packet when a specific number of previous first type of packets are discarded.

15. The method of claim 1, wherein the step of modifying the priority of the first type of packet when the first type of packet is interfered comprises:
decreasing the priority of the first type of packet when a specific number of previous first type of packets are received successfully.

16. The method of claim 1, wherein the step of modifying the priority of the first type of packet when the first type of packet is interfered is performed in a hardware manner.

17. The method of claim 16, wherein hardware of the first wireless system modifies the priority of the first type of packet when the first type of packet is interfered.

18. The method of claim 16, wherein hardware of the first wireless system modifies following first type of packets when the first type of packet is interfered.

19. The method of claim 1, wherein the step of modifying the priority of the first type of packet when the first type of packet is interfered is performed in a software manner.

20. The method of claim 19, wherein the first wireless system sends an interrupt signal to a processing unit to modify a priority of following first type of packets when the first type of packet is interfered.
